(19) United States
(12) Patent Application Publication
(10) Pub. No.: US 2012/0279470 A1
(43) Pub. Date: Nov. 8, 2012

(54) ENGINE FOR COMBUSTING FUEL

(76) Inventor: Sheldon Kiroff, Mason City, IA (US)

(21) Appl. No.: 13/099,569

(22) Filed: May 3, 2011

(51) Int. Cl. F02P 7/06

(52) U.S. Cl. 123/146.5 R

(57) ABSTRACT

An engine for combusting fuel that has a head mounted to an engine block with a gasket disposed therebetween. A chamber is formed within the engine block and head that is frustroconical in shape to direct the energy wave created by the fuel to a reciprocating piston that is disposed within the chamber in the engine block. The gasket has electrical components therein including at least one electrode that extends into the chamber such that when activated the electrode provides a spark in the chamber.

### BACKGROUND OF THE INVENTION

This invention is related to piston actuating engines for combusting fuel. More specifically, this invention relates to an internal combustion engine.

Piston actuated engines that combust fuel are well known in the art. Basically, internal combustion engines have an engine that has a chamber disposed therein where a piston reciprocates within the chamber. A head is typically mounted to the engine block and contains an intake passageway and an exhaust passageway wherein the intake passageway has an intake valve therein and the exhaust passageway has an exhaust valve therein. Additionally, typically disposed within the head is a spark plug that ignites fuel in the chamber to create an explosion in the chamber to act upon the piston.

While the internal combustion engine functioning is well known, problems still remain. Specifically, the explosion within the chamber caused by the spark plug creates diverging waves where as the energy waves gets larger and larger the wave becomes less powerful in force until it acts upon the piston. In this manner energy is lost during the combustion cycle as a result of the diverging wave front. Thus, a need in the art exists to either minimizes or eliminates these diverging waves within the chamber of an internal combustion engine in order to maximize the efficiency of the explosion of the fuel within the chamber.

A first solution for this problem can be seen in U.S. Pat. No. 7,909,011 entitled PISTON ACTUATING ENGINE FOR COMBUSTING FUEL that is incorporated herein. In that application the chamber was frustroconical in shape in order to focus the waves from the ignition of the fuel to converge on one another as an implosion, concentrating more power to the piston. While this presented a vast improvement over current internal combustion engines, such an engine still presented deficiencies.

Specifically, the spark presented by the traditional spark plug creates the ignition of fuel at an outermost part of the chamber thus still presenting spherical diverging waves that cause the inefficiencies discussed. For that matter, all internal combustion engines still present the use of the spark plug at an extreme end of the chamber thus creating such spherical diverging waves. Thus, a need in the art exists to provide an internal combustion engine that minimizes the divergence of energy waves to a reciprocating piston. Such inefficiency cause more fuel to be consumed than needed and more exhaust as a result harming the environment.

Thus, a principal object of the present invention is to increase efficiency of an internal combustion engine.

Yet another object of the present invention is to minimize the fuel required to operate an internal combustion engine.

These and other objects, features, and advantages will become apparent from the specification and claims.

### BRIEF SUMMARY OF THE INVENTION

An engine for combusting fuel. The engine includes an engine block and head mounted on the engine block where a chamber is formed within the engine block and head such that the head receives fuel contained within the chamber. A gasket is disposed between the engine block and the head to provide a seal between the engine block and head. The gasket has electrical components therein that are electrically connected to at least one electrode that extends into the chamber such that when actuated the electrode provides a spark within the chamber.

### BRIEF DESCRIPTION OF THE DRAWINGS

FIG. 1 is a side plan view of an internal combustion engine;

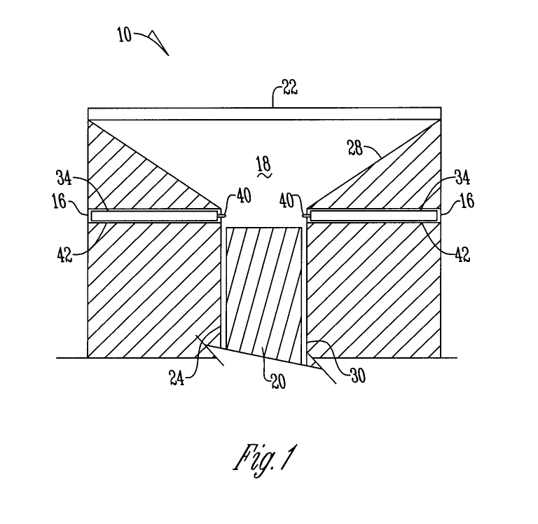

FIG. 2 is a top plan and schematic view of a gasket for an internal combustion engine; and

FIG. 3 is a top perspective view of an engine block of an internal combustion engine;

FIG. 4 is a bottom perspective view of an engine block of an internal combustion engine.

### DETAILED DESCRIPTION OF THE PREFERRED EMBODIMENT

The figures provide an internal combustion engine 10. While shown as an internal combustion engine 10 in the figures, one skilled in the art should appreciate that the present design can be directed toward any piston actuated combustion engine such as a diesel engine or the like. The internal combustion engine 10 has an engine block 12 that has a head 14 mounted thereon with a gasket 16 providing a seal between the engine block 12 and head 14. Disposed within the engine block 12 and head 14 is a combustion chamber 18 that receives a reciprocating piston 20 therein.

The chamber 18 extends from a first end in the head 14 where fuel is received by an input valve and exhaust exits through an exhaust port valve as is known in the art, to a second end within the engine block 12 wherein the piston 20 reciprocates. The valving that inputs fuel and expels exhaust is well known in the art and conventional and therefore not shown in the figures.

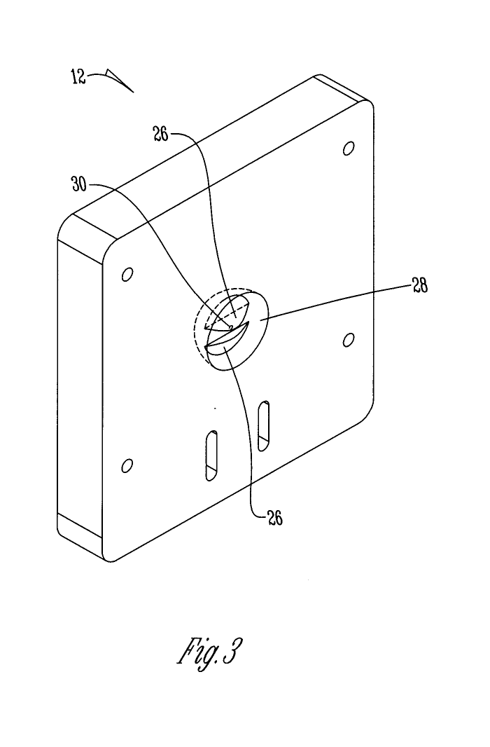

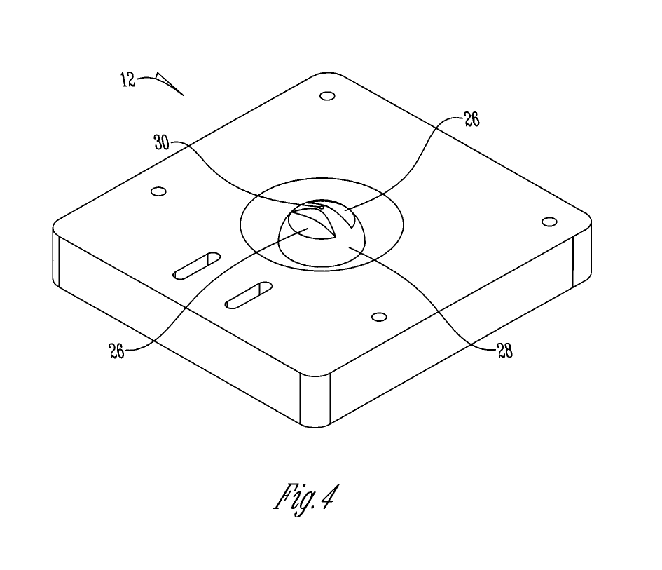

The chamber 18 in one embodiment as best shown in FIGS. 3 and 4 has rounded or arcuate protrusions 26 that extend into the chamber formed into an angled sidewall 28 that provides a frustroconical shape for the chamber 18. The sidewall 28 terminates in a cylindrical portion 30 where the piston 20 reciprocates within the cylindrical portion 30. Thus, the diameter of the chamber 18 at its first end 22 is larger than the diameter of the chamber at the second end 24 and specifically the cylindrical portion 30.

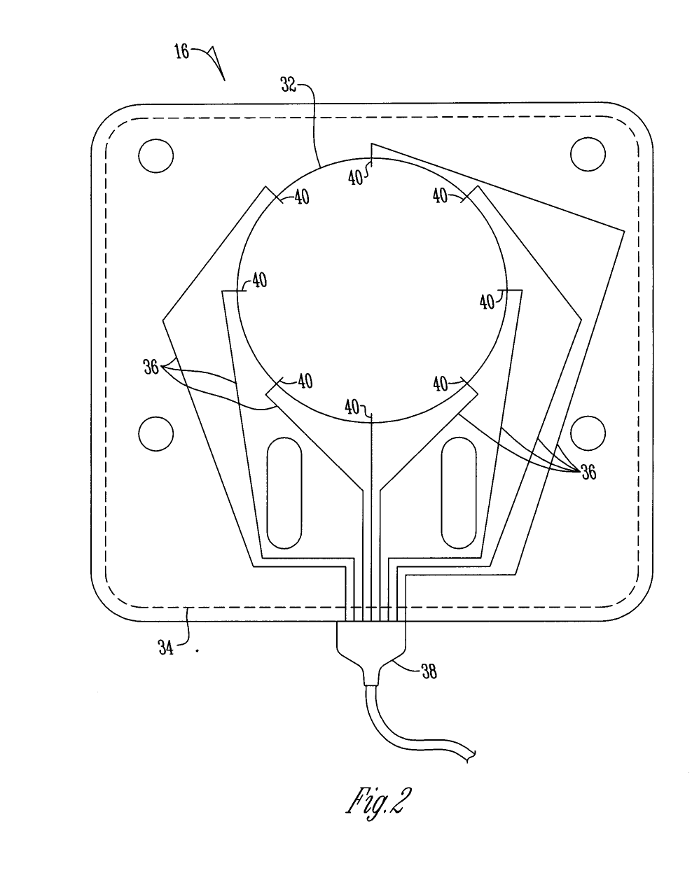

As best shown in FIG. 2 the gasket 16 includes means for attaching and sealing the connection between the engine block 12 and head 14. The gasket 16 additionally has an opening 32 to accommodate the cylindrical portion 30 of the chamber 18. The gasket 16 additionally has a printed circuit board (PCB) 34 including electronic components 36 therein that are electrically connected to an electrical connector 38 that is electrically connected to and in communication with the ignition coil (not shown). A plurality of electrodes 40 are electrically connected and extend from the electrical components 36 and into the chamber 18.

Thus, as a result of the electrical connection to the ignition coil electricity is passed through the electrical components 36 of the PCB 34 to the electrodes 40 such that the electrodes 40 can cause a spark to occur in a hemi-spherical fashion at the gasket 16 within chamber 18. The PCB is surrounded by an insulating layer 42 such that the gasket 16 can continue to function as a seal between the engine block 12 and head 14 and to ensure fuel or the explosion within chamber 18 does not contaminate or affect the PCB 34 or electrical components 36 within the gasket 16.

One skilled in the art will appreciate that electronic components 36 can provide either positive or a negative contact points wherein the PCB 34 itself can contain the opposite contact point to initiate a spark. Alternatively, either the block 12 or head 14 may have the opposite contact point in order to initiate a spark. In addition, the electrical components 36 and PCB 34 are insulated by the insulating layer 42 with only the electrodes 40 protruding into the chamber 18. In a preferred embodiment the electrode is made of iridium.

In operation, fuel enters the chamber 18 at the head 14 as is conventional in the art. The fuel is then directed via the arcuate walls 26 toward the cylindrical portion 30 of the chamber 18. At this time the ignition coil activates thus sending an electrical signal through the electronic components 36 to the electrodes 40 causing a hemispheric spark and thus uniform and symmetric flame front adjacent the gasket 16. Then in combination with the frustroconically shaped chamber 18 the wave of energy caused as a result of the explosion results in a converging energy wave in order to reciprocate the piston. After reciprocation the exhaust created from the explosion is displaced through a valve via the head 14 as is conventional in the art.

Thus, presented is an engine that presents not only a specially shaped chamber 18 but additionally a spark within the chamber at the cylindrical portion 30 in a hemispheric pattern via electrodes 40 to ensure a converging energy wave occurs to reciprocate piston 20. Thus, by placing the electrodes 40 and thus creating the spark adjacent the gasket 16 the energy resulting from the explosion within chamber 18 is concentrated on piston 20 in order to maximize the efficiency of the explosion. Thus, less fuel is needed to reciprocate the piston as required by a vehicle and in addition the less exhaust is created as a result of less fuel being required. While the chamber 18 in the figures is shown as a being frustroconical in shape, the use of the gasket having electronic components 36 to create a spark improves engine efficiency regardless of the shape of the chamber 18, including in hemi engines. Thus, at the very least all of the stated objective have been met.

It will be appreciated by those skilled in the art that other various modifications could be made to the device without departing from the spirit and scope of this invention. All such modifications and changes fall within the scope of the claims and are intended to be covered thereby.

What is claimed is:

1. An engine for combusting fuel comprising:
an engine block;
a head mounted on the engine block;
a chamber formed within the engine block and head that receives fuel at the head;
a reciprocating piston disposed within the chamber for compressing the fuel in the chamber; and
a gasket disposed between the engine block and head and having electronic components therein electrically connected to at least one electrode that extends into the chamber such that when actuated the electrode provides a spark in the chamber.

2. The engine of claim 1 wherein the electronic components are on a circuit board disposed in the gasket.

3. The engine of claim 2 wherein the circuit board is surrounded by an insulating layer that engages the engine block and head.

4. The engine of claim 1 wherein the at least one electrode is a positive electrode.

5. The engine of claim 4 wherein the engine block is a negative contact point to cause the spark with the positive electrode.

6. The engine of claim 4 wherein the head is a negative contact point to cause the spark with the positive electrode.

7. The engine of claim 1 wherein the chamber has a first end with a first diameter and a sidewall tapering from the first end to a second end with a second diameter that is less than the first diameter.

8. The engine of claim 7 wherein the chamber has a frustroconical shape.

9. The engine of claim 8 wherein the sidewall has at least one arcuate protrusion extending into the chamber.
